(19) United States
(12) Patent Application Publication
(10) Pub. No.: US 2014/0073383 A1
(43) Pub. Date: Mar. 13, 2014

(54) METHOD AND SYSTEM FOR MOTION COMPARISON

(71) Applicant: INDUSTRIAL TECHNOLOGY RESEARCH INSTITUTE, Hsinchu (TW)

(72) Inventors: Tung-Hung Lu, Yilan County (TW); Hsing-Chen Lin, Taichung City (TW); Rong-Rong Chen, Taipei City (TW); Yueh-Hsuan Lee, Hsinchu County (TW); Ji-Ding Chen, Yunlin County (TW)

(21) Appl. No.: 13/849,535

(22) Filed: Mar. 24, 2013

Related U.S. Application Data
(60) Provisional application No. 61/699,877, filed on Sep. 12, 2012.

(30) Foreign Application Priority Data
Dec. 13, 2012 (TW) 101147275

(51) Int. Cl. A63F 13/04

(52) U.S. Cl. CPC A63F 13/04
USPC 463/7

(57) ABSTRACT

A method and a system for motion comparison, especially for functions of a multimode motion streaming comparison, are provided. The method includes: obtaining a streaming motion and nodes of a user according to images of the user; providing a streaming motion and nodes of a virtual coach; calculating relation values between coordinates of the nodes of the user and those of the virtual coach according to a streaming node comparison algorithm; obtaining weights via a weighting vector according to parts of body, exercise types and time information; generating a comparison result according to a result of the weights respectively multiplying the relation values; mapping the comparison result to a similarity value. Therefore, a continuous motion compliance of individual trained parts of body of the user is improved, and the correctness for the user to fathom postures is improved effectively.

### CROSS-REFERENCE TO RELATED APPLICATION

This application claims the priority benefits of U.S. provisional application Ser. No. 61/699,877, filed on Sep. 12, 2012 and Taiwan application serial no. 101147275, filed on Dec. 13, 2012. The entirety of each of the above-mentioned patent applications is hereby incorporated by reference herein and made a part of this specification.

### BACKGROUND

1. Technical Field

The disclosure relates to a multimode motion streaming comparison method and system capable of adjusting weights according to a weighting vector and performing calculations according to a streaming node comparison algorithm.

2. Related Art

In motion sensing fitness games sold in the market, a virtual personal coaching course can edit personalized training courses according to fitness training parts input by a user. These training courses can give a score to the user according to a motion of the user and a motion of the virtual personal coaching course. The user can realize whether his motion is correct according to the score. However, the score is only given for a specific fixed-point motion of the user, and the score cannot provide a continuous using experience for the user. Moreover, due to a demand for personalized training goal setting, the user expects to perform exercises to strengthen and train hands, feet, a specific part of body, and the transferring center of gravity of a body when fathoming and following exercises of the virtual personal coach. On the other hand, the user can also have a demand of training endurance of lower limbs (for example, a degree of a squat and a stand, and a duration of the exercise, etc.), so as to improve a heart rate to achieve an effect of fitness.

Therefore, it is an important issue concerned by related technicians to provide a continuous streaming motion comparison method in line with the user's needs.

### SUMMARY

An exemplary embodiment of the disclosure provides a multimode motion streaming comparison method and system capable of adjusting weights according to a weighting vector and performing calculations according to a streaming node comparison algorithm. Therefore, a continuous motion compliance of individual trained parts of body of a user is improved, and the correctness for the user to fathom postures also can be improved effectively.

An exemplary embodiment of the disclosure provides a motion comparison system including a user motion acquisition unit, a virtual coach motion information unit, a first calculation unit, a multi-dimension weighting selector, a second calculation unit and a mapping unit. The user motion acquisition unit is used to obtain a first streaming motion of a user and a plurality of nodes of the first streaming motion according to a plurality of images of the user, where each node of the first streaming motion includes a plurality of coordinates, and each node of the first streaming motion belongs to a part of body. The virtual coach motion information unit is used to provide a second streaming motion of a virtual coach and a plurality of nodes of the second streaming motion, where each node of the second streaming motion includes a plurality of coordinates, and each node of the second streaming motion belongs to one of the parts of body. The first calculation unit is coupled to the user motion acquisition unit and the virtual coach motion information unit, and calculates a plurality of relation values between the coordinates of the nodes of the first streaming motion and the coordinates of the nodes of the second streaming motion according to a streaming node comparison algorithm. The multi-dimension weighting selector is used to obtain a plurality of weights via a weighting vector according to the parts of body, a plurality of exercise types preset by the user and time information of the images. The second calculation unit is coupled to the first calculation unit and the multi-dimension weighting selector, and generates a comparison result according to a result of the weights respectively multiplying the relation values. The mapping unit is coupled to the second calculation unit, and maps the comparison result to a similarity value.

According to another aspect, the disclosure provides a motion comparison method, which is adapted to an electronic device. The motion comparison method includes following steps. A first streaming motion of a user and a plurality of nodes of the first streaming motion are obtained according to images of the user, where each node of the first streaming motion includes a plurality of coordinates, and each node of the first streaming motion belongs to a part of body. A second streaming motion of a virtual coach and a plurality of nodes of the second streaming motion are provided, where each node of the second streaming motion includes a plurality of coordinates, and each node of the second streaming motion belongs to one of the parts of body. A plurality of relation values between the coordinates of the nodes of the first streaming motion and the coordinates of the nodes of the second streaming motion are calculated according to a streaming node comparison algorithm. A plurality of weights are obtained via a weighting vector according to the parts of body, a plurality of exercise types preset by the user and time information of the images. A comparison result is generated according to a result of the weights respectively multiplying the relation values. The comparison result is mapped to a similarity value.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a virtual coach guiding a user to do exercise according to an exemplary embodiment of the disclosure.

FIG. 2 is a block diagram of a motion comparison apparatus according to an exemplary embodiment of the disclosure.

FIG. 3 is a schematic diagram of nodes of a plurality of parts of body according to an exemplary embodiment of the disclosure.

FIG. 4 is an operation schematic diagram of a motion comparison system according to an exemplary embodiment of the disclosure.

FIG. 5 is a schematic diagram of a three-dimensional matrix according to an exemplary embodiment of the disclosure.

FIG. 6 is an operation schematic diagram of a mapping unit according to an exemplary embodiment of the disclosure.

FIG. 7 is a flowchart illustrating a motion comparison method according to an exemplary embodiment of the disclosure.

### DETAILED DESCRIPTION OF DISCLOSED EMBODIMENTS

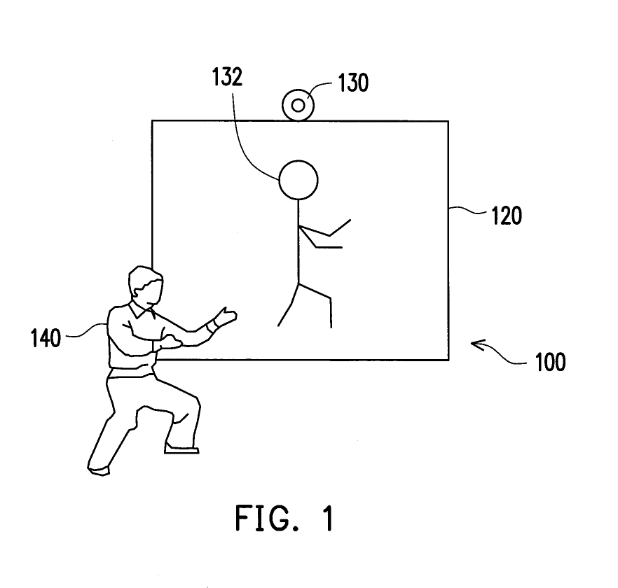

FIG. 1 is a schematic diagram of a virtual coach guiding a user to do exercise according to an exemplary embodiment of the disclosure.

Referring to FIG. 1, a motion comparison apparatus 100 includes a screen 120 and a sensor 130. The sensor 130 is used to detect a motion of a user 140. For example, the sensor 130 includes a video camera or an infrared sensor. When the user 140 activates the motion comparison apparatus 100, the screen 120 displays a virtual coach 132. The virtual coach 132 starts to demonstrate one or a plurality of motions, and the user 140 learns the motion. The screen 120 can further display motion information including motion similarity or other related information (for example, an exercise type, time and score, etc.) to facilitate the user 140 learning whether his motion is correct.

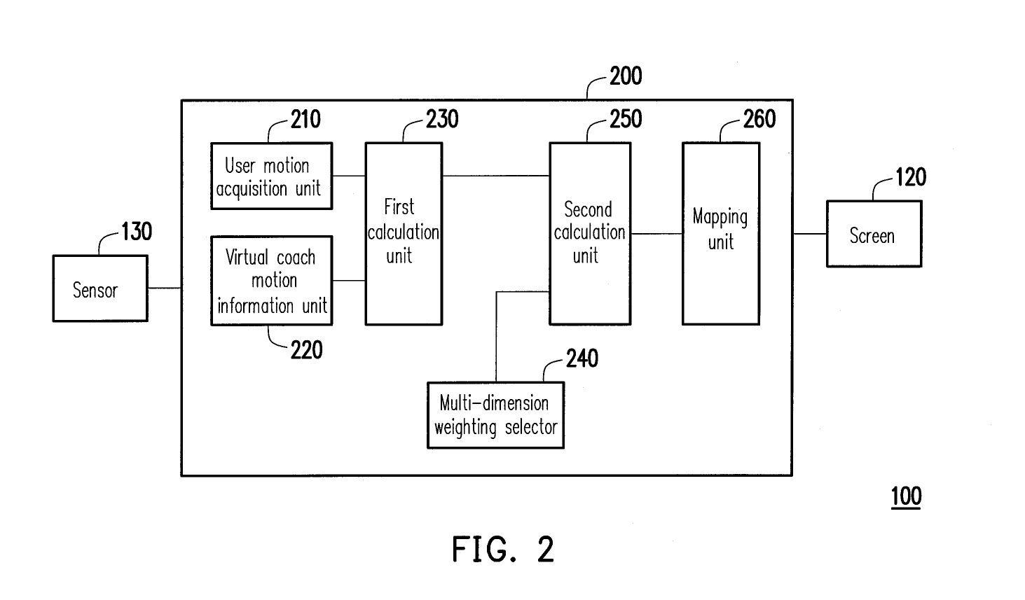

FIG. 2 is a block diagram of a motion comparison apparatus according to an exemplary embodiment of the disclosure.

Referring to FIG. 2, the motion comparison apparatus 100 includes a motion comparison system 200, which includes a user motion acquisition unit 210, a virtual coach motion information unit 220, a first calculation unit 230, a multi-dimension weighting selector 240, a second calculation unit 250 and a mapping unit 260. In the present exemplary embodiment, each of the units in the motion comparison system 200 is implemented as a circuit.

The sensor 130 captures a plurality of images of the user 140, and transmits the images to the user motion acquisition unit 210. The user motion acquisition unit 210 obtains a streaming motion (which is also referred to as a first streaming motion) of the user 140 and a plurality of nodes of the streaming motion according to the images, where each node belongs to one part of body (for example, head or hand). In an exemplary embodiment, the images include information of brightness and depth of field, and each node includes a plurality of coordinates representing a three-dimensional (3D) space. In other words, the streaming motion of the user 140 is a continuous motion performed in the 3D space.

The virtual coach motion information unit 220 provides a streaming motion (which is also referred to as a second streaming motion) of a virtual coach and a plurality of nodes of the streaming motion, where each node of the streaming motion of the virtual coach belongs to one part of body, and each node includes a plurality of coordinates. The first calculation unit 230 calculates a plurality of relation values between coordinates of the nodes of the user and coordinates of the nodes of the coach according to a streaming node comparison algorithm. The relation values are used to represent whether the motion of the user 140 is similar to the motion of the virtual coach 132.

Particularly, the multi-dimension weighting selector 240 obtains a plurality of weights according to the parts of body corresponding to the nodes, a plurality of exercise types preset by the user and time information of the images sensed by the sensor 130. For example, if the user wants to strengthen the exercise on lower limb muscles, the weights corresponding to the parts of the lower limbs are relatively large (compared to the weights corresponding to the parts of the upper limbs). For example, the exercise type preset by the user is dancing emphasizing the feet of the lower limbs, the multi-dimension weighting selector 240 selects the weights corresponding the dancing emphasizing the feet of the lower limbs from a database. Alternatively, when the user wants to train the parts of the lower limbs in the first five minutes of the exercise, the weights corresponding to the parts of the lower limbs are relatively large in the first five minutes.

The second calculation unit 250 respectively multiplies the weights with the relation values, and generates a comparison result according to a result of the multiplication. The mapping unit 260 is coupled to the second calculation unit 250, and maps the comparison result to a similarity value. For example, the further the motion of the user 140 is similar to the motion of the virtual coach 132, the higher the similarity value is. The similarity value is displayed on the screen 120 to facilitate the user 140 learning whether his motion is correct. Particularly, the motion comparison system 200 generates one similarity value for each image captured by the sensor 130, and displays the similarity values on the screen 120. In this way, the user can realize whether his continuous motion is correct at any time.

An exemplary embodiment is provided below to describe operations of the units in the motion comparison system 200 in detail.

First, the user 140 inputs one or a plurality of settings to the motion comparison apparatus 100. For example, the user 140 selects an exercise type, an exercise duration, an exercise strength or a part of body to be strengthened. Then, the sensor 130 continually obtains a streaming image of the user. The streaming image includes a plurality of images, and each image corresponds to different time information. In an exemplary embodiment, the time information can be represented as a certain second. Alternatively, the time information can be used to represent as a certain image in the streaming image.

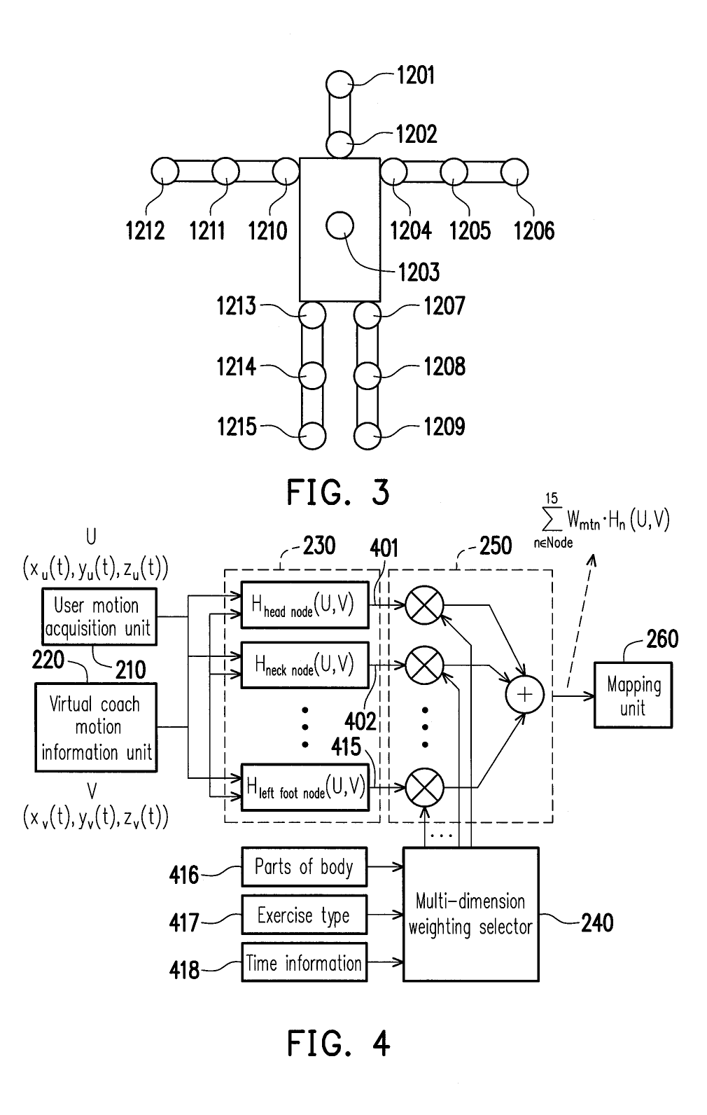

FIG. 3 is a schematic diagram of nodes of a plurality of parts of body according to an exemplary embodiment of the disclosure.

Referring to FIG. 3, the user motion acquisition unit 210 obtains the streaming motion of the user 140 according to the streaming image obtained by the sensor 130, and calculates a plurality of nodes. In the present exemplary embodiment, the number of the nodes is 15, and the nodes respectively belong to 15 parts of body of the user. The nodes are respectively a head node 1201, a neck node 1202, a torso center node 1203, a right shoulder node 1204, a right elbow node 1205, a right hand node 1206, a right hip node 1207, a right knee node 1208, a right foot node 1209, a left shoulder node 1210, a left elbow node 1211, a left hand node 1212, a left hip node 1213, a left knee node 1214, and a left foot node 1215. The nodes 1201-1215 are located on major joint of human body, and the user motion acquisition unit 210 determines the continuous motion of the user according to the streaming image, and calculates the nodes 1201-1215 according to the continuous motion. However, in other exemplary embodiment, the user motion acquisition unit 210 can also calculate more or less number of the nodes. Alternatively, the user motion acquisition unit 210 can also calculate nodes of other parts of body, which is not limited by the disclosure. In the present exemplary embodiment, each node includes a coordinate of an x-direction, a coordinate of a y-direction and a coordinate of a z-direction. Here, the three coordinates of one node of the user are represented as (xᵤ(t), yᵤ(t), zᵤ(t)), where t represents the time information. On the other hand, the vector U is used to represent the coordinates of all of the nodes within a duration.

On the other hand, the virtual coach motion information unit 220 provides the streaming motion of the virtual coach, the nodes of the streaming motion and the coordinates of the nodes. For example, the motion comparison apparatus 200 includes a database, which stores streaming images of a plurality of exercise types. Each of the streaming images includes a plurality of images of different time. Each image includes 15 nodes respectively belonging to the aforementioned 15 parts of body. Each node of the virtual coach also includes a coordinate of the x-direction, a coordinate of the y-direction and a coordinate of the z-direction. Here, corresponding to time information t, the three coordinates of one node of the virtual coach are represented as (xᵥ(t), yᵥ(t), zᵥ(t)), and the vector V is used to represent the coordinates of all of the nodes within a duration.

FIG. 4 is an operation schematic diagram of a motion comparison system according to an exemplary embodiment of the disclosure.

Referring to FIG. 4, the user motion acquisition unit 210 transmits the vector U to the first calculation unit 230, and the virtual coach motion information unit 220 transmits the vector V to the first calculation unit 230. Regarding each part of body and each time information t, the first calculation unit 230 calculates a relation value between the vector U and the vector V according to a streaming node comparison algorithm. The streaming node comparison algorithm can be a dynamic time warping (DTW) algorithm, a Euclidean distance (ED) algorithm or a coefficient of correlation (CC) algorithm. A basic principle of the DTW algorithm is to compare a similarity degree between two time sequences. A principle of the ED algorithm is to calculate a distance between two points in space, and the greater the distance is, the less similarity the two points have. The CC algorithm is to determine a correlation degree between two time sequences. The contents of the streaming node comparison algorithms are known by those skilled in the art, and details thereof are not repeated.

The streaming node comparison algorithm adopted by the first calculation unit 230 can be represented by a function Hₙ( ), which is used to calculate the relation value of an n-th part of body. Taking the ED algorithm and the head node as an example, the first calculation unit 230 calculates Euclidean distances between the three coordinates (xᵤ(t), yᵤ(t), zᵤ(t)) of the head node of the user and the three coordinates (xᵥ(t), yᵥ(t), zᵥ(t)) of the head node of the virtual coach at the time information t, so as to generate a relation value 401 (which is represented as H_{head node}(U,V)). Similarly, the first calculation unit 230 can also calculate corresponding relation values (for example, relation values 402-415) for the other parts of body.

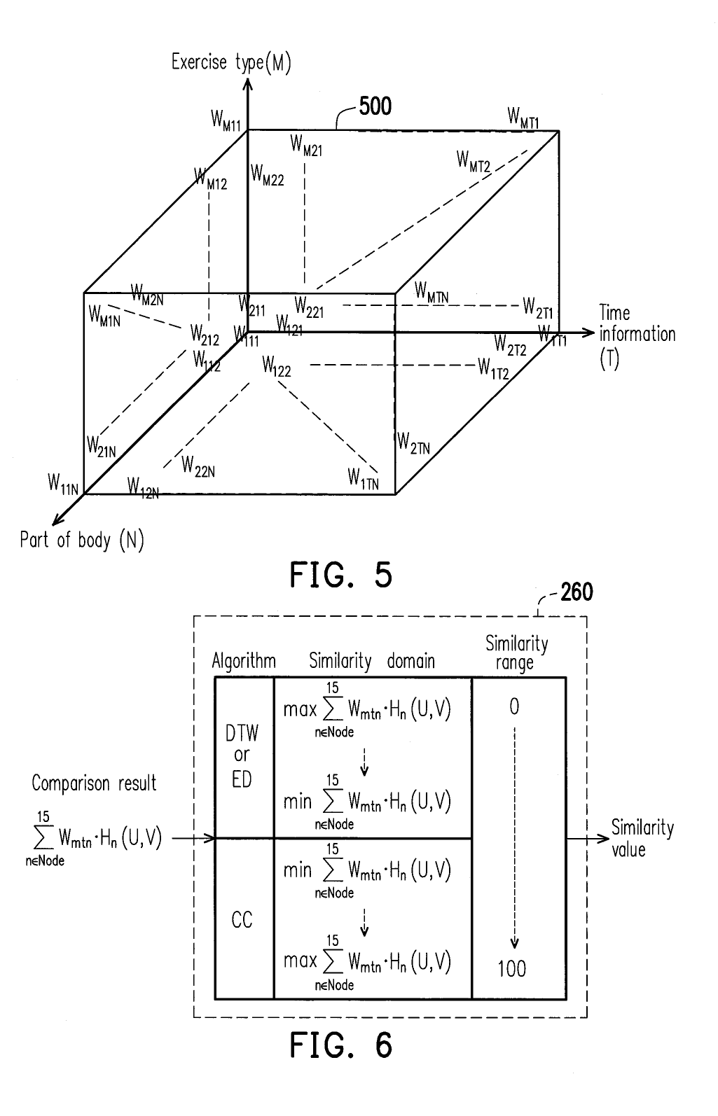

On the other hand, the multi-dimension weighting selector 240 obtains a plurality of weights via a weighting vector according to parts of body 416, an exercise type 417 and time information 418 preset by the user. Here, the weighting vector includes the three dimensions of the parts of body 416, the exercise type 417 and the time information 418. For example, one of the parts of body 416 can be represented by an integer from 1 to 15 (for example, “1” represents the head node), and different exercise types 417 can also be represented by a plurality of discrete values (for example, “0” represents Taichi, and “1” represents ballroom dancing), and the time information 418 can be represented by a number of seconds of the video. The weighting vector composed of one of the parts of body 416, the exercise type 417 and the time information 418 determines a position on a three-dimensional (3D) matrix 500 (shown in FIG. 5). A weight on the 3D matrix 500 can be represented by Wₘₜₙ, which represents a weight of a certain exercise type (m), certain time information (t) and a certain part of body (n), where m and n are positive integers, and t is a real number. In another exemplary embodiment, the weighting vector may also include more dimensions. For example, the weighting vector may include a dimension of a degree of difficulty or user's preference, which is not limited by the disclosure.

Referring to FIG. 5, if the user does not consider the exercise type 417 and the time information 418, the multi-dimension weighting selector 240 may obtain the weights (corresponding to an N-axis) only according to the parts of body 416. For example, in case of ballroom dancing hand training, the weights corresponding to the hand nodes are relatively large, and in case of ballroom dancing foot training the weights corresponding to the foot nodes are relatively large. On the other hand, if the user does not consider the time information 418, the multi-dimension weighting selector 240 may obtain the weights (corresponding an M-N plane) only according to the exercise type 417 and the parts of body 416. For example, in case of Taichi, the weights corresponding to the nodes emphasizing the hands and a center of gravity of lower part of body are relatively large, and in case of stepping, the weights corresponding to the nodes emphasizing the feet of the lower part of body are relatively large. If the user does not consider the exercise type 417, the multi-dimension weighting selector 240 may obtain the weights (corresponding an N-T plane) only according to the parts of body 416 and the time information 418. For example, the user may set to emphasize the exercise of the upper part of body in a first half of the exercise, so that the weights corresponding to the upper part of body nodes are relatively large, and the user may set to emphasize the exercise of the lower part of body in a last half of the exercise, and the weights corresponding to the lower part of body nodes are relatively large.

Here, the weights generated by the multi-dimension weighting selector 240 are real numbers, and values of the weights are greater than or equal to 0.1 and are smaller than or equal to 2. The greater the value of the weight is, the more important of the corresponding part of body is. However, if the value of the weight is set to be too large (more than 2), an inaccurate motion of the user is enlarged, which may result in a fact that the user is not easy to get a high similarity value. However, in other exemplary embodiments, the weights can also be set to other values, which is not limited by the disclosure.

Referring to FIG. 4, the multi-dimension weighting selector 240 transmits the obtained weights to the second calculation unit 250. The second calculation unit 250 respectively multiplies the weights by the relation values 401-415, and adds results of the multiplications to obtain a comparison result. For example, the second calculation unit 250 generates the comparison result according to a following equation (1).

$${\sum }_{n ∈ Node}^{15} {W}_{mtn} \cdot {H}_{n} ( U , V ) \qquad ( 1 )$$

Node is a set formed by all of the parts of body. In the present exemplary embodiment, the second calculation unit 250 calculates a comparison result for each of the images in the streaming motion of the user and each of the images of the virtual coach. The second calculation unit 250 transmits the comparison results to the mapping unit 260.

FIG. 6 is an operation schematic diagram of the mapping unit according to an exemplary embodiment of the disclosure.

Referring to FIG. 6, the mapping unit 260 receives a plurality of the comparison results, and obtains a maximum comparison result and a minimum comparison result from the comparison results. In FIG. 6, the maximum comparison result is represented by a following equation (2), and the minimum comparison result is represented by a following equation (3):

$$\begin{matrix}max {\sum }_{n ∈ Node}^{15} {W}_{mtn} \cdot {H}_{n} ( U , V ) & ( 2 ) \\ min {\sum }_{n ∈ Node}^{15} {W}_{mtn} \cdot {H}_{n} ( U , V ) & ( 3 )\end{matrix}$$

The mapping unit 260 generates a similarity domain according to the minimum comparison result and the maximum comparison result. The mapping unit 260 may also define a similarity range (for example, 0 to 100). The mapping unit 260 maps a comparison result from the similarity domain to the similarity range according to the minimum comparison result and the maximum comparison result. For example, when the streaming node comparison algorithm adopted by the first calculation unit 230 is the DTW algorithm or the ED algorithm, the maximum comparison result is mapped to 0, and the minimum comparison result is mapped to 100. On the other hand, when the streaming node comparison algorithm adopted by the first calculation unit 230 is the CC algorithm, the maximum comparison result is mapped to 100, and the minimum comparison result is mapped to 0. When a comparison result is between the minimum comparison result and the maximum comparison result, the comparison result is mapped to similarity values between 0-100. The second calculation unit 250 can generate the similarity values between 0-100 through a linear or non-linear manner, which is not limited by the disclosure. Moreover, in other exemplary embodiments, the mapping unit 260 may also define the other similarity domains (for example, 0-10), which is not limited by the disclosure. Finally, the mapping unit 260 transmits the generated similarity values to the screen 120.

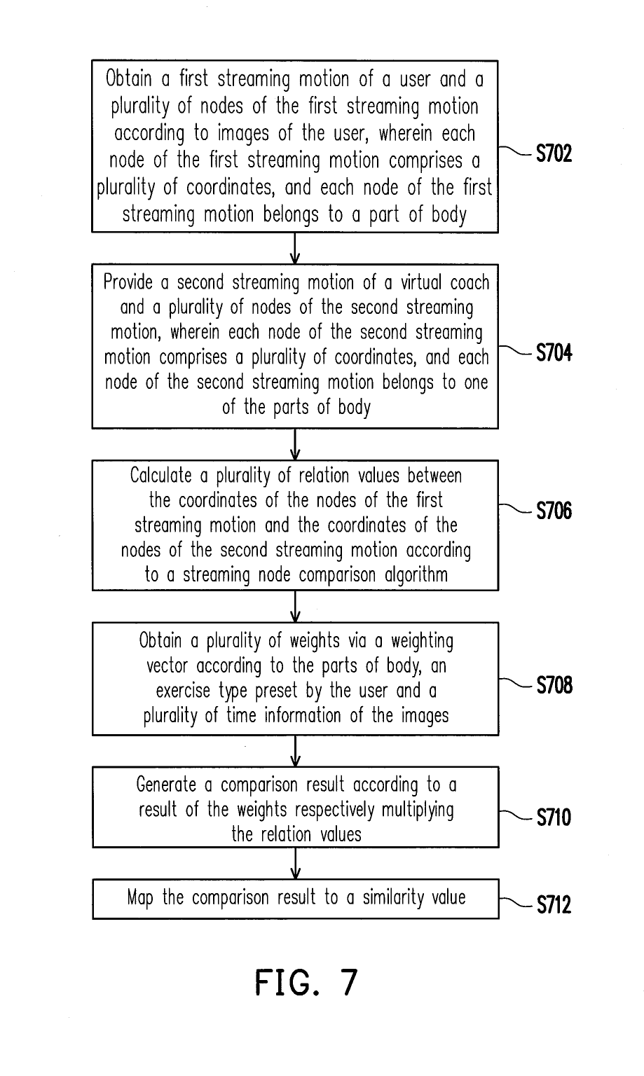

FIG. 7 is a flowchart illustrating a motion comparison method according to an exemplary embodiment of the disclosure.

Referring to FIG. 7, in step S702, a first streaming motion of a user and a plurality of nodes of the first streaming motion are obtained according to images of the user, where each node of the first streaming motion includes a plurality of coordinates, and each node of the first streaming motion belongs to a part of body. In step S704, a second streaming motion of a virtual coach and a plurality of nodes of the second streaming motion are provided, where each node of the second streaming motion includes a plurality of coordinates, and each node of the second streaming motion belongs to one of the parts of body. In step S706, a plurality of relation values between coordinates of the nodes of the first streaming motion and coordinates of the nodes of the second streaming motion are calculated according to a streaming node comparison algorithm. In step S708, a plurality of weights are obtained via a weighting vector according to the parts of body, a plurality of exercise types preset by the user and time information of the images. In step S710, a comparison result is generated according to a result of the weights respectively multiplying the relation values. In step S712, the comparison result is mapped to a similarity value. Details of the steps of FIG. 7 have been described above, which are not repeated.

In an exemplary embodiment, the steps in FIG. 7 can be implemented as a plurality of program codes. The program codes are stored in a memory of an electronic apparatus. The electronic apparatus includes a processor to execute the program codes. The electronic apparatus can be implemented as a computer, a television, a game machine, or any of embedded systems. Alternatively, the steps of FIG. 7 can be implemented as one or a plurality of circuits, and in the disclosure, it is not limited to use a software manner or a hardware manner to implement the steps of FIG. 7.

In the motion comparison system and the motion comparison method provided by the exemplary embodiments of the disclosure, especially a multimode motion streaming comparison system and method, a plurality of weights can be selected via a weighting vector according to the time information, the parts of body and the exercise types, and the weights can be used to calculate a similarity value. In this way, the user can strengthen the parts of body to be exercised according to an instruction of the coach, so as to improve an exercise effect.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A motion comparison system, comprising:
a user motion acquisition unit, obtaining a first streaming motion of a user and a plurality of nodes of the first streaming motion according to a plurality of images of the user, wherein each of the nodes of the first streaming motion comprises a plurality of coordinates, and each of the nodes of the first streaming motion belongs to a part of body;
a virtual coach motion information unit, providing a second streaming motion of a virtual coach and a plurality of nodes of the second streaming motion, wherein each of the nodes of the second streaming motion comprises a plurality of coordinates, and each of the nodes of the second streaming motion belongs to one of the parts of body;
a first calculation unit, coupled to the user motion acquisition unit and the virtual coach motion information unit, calculating a plurality of relation values between the coordinates of the nodes of the first streaming motion and the coordinates of the nodes of the second streaming motion according to a streaming node comparison algorithm;
a multi-dimension weighting selector, obtaining a plurality of weights via a weighting vector according to the parts of body, a plurality of exercise types preset by the user and time information of the images;
a second calculation unit, coupled to the first calculation unit and the multi-dimension weighting selector, generating a comparison result according to a result of the weights respectively multiplying the relation values; and
a mapping unit, coupled to the second calculation unit, and mapping the comparison result to a similarity value.

2. The motion comparison system as claimed in claim 1, wherein a number of the nodes of the user is 15, a number of the nodes of the virtual coach is 15.

3. The motion comparison system as claimed in claim 1, wherein the weights are real numbers, and values of the weights are greater than or equal to 0.1 and are smaller than or equal to 2.

4. The motion comparison system as claimed in claim 2, wherein an operation that the second calculation unit generates the comparison result comprises:
the second calculation unit generates the comparison result according to the equation (1),
$${\sum }_{n ∈ Node}^{15} {W}_{mtn} \cdot {H}_{n} ( U , V ) \qquad ( 1 )$$
wherein, U is a vector comprising the coordinates of the nodes of the user, V is a vector comprising the coordinates of the nodes of the virtual coach, Wₘₜₙ is the weight corresponding to an n-th part of body in the parts of body, an m-th exercise type in the exercise types and a t-th second in the time information, Hₙ( ) is a function corresponding to the streaming node comparison algorithm and is used to calculate the relation value corresponding to the n-th part of body, m and n are positive integers, t is a real number, and Node is a set formed by the parts of body.

5. The motion comparison system as claimed in claim 1, wherein the streaming node comparison algorithm is a dynamic time warping algorithm, a Euclidean distance algorithm or a coefficient of correlation algorithm.

6. The motion comparison system as claimed in claim 1, wherein the second calculation unit generates a plurality of second comparison results,
the mapping unit obtains a minimum comparison result and a maximum comparison result from the second comparison results, and maps the comparison result to the similarity value in a similarity range according to the minimum comparison result and the maximum comparison result.

7. The motion comparison system as claimed in claim 6, wherein the similarity range is 0 to 100.

8. A motion comparison method, adapted to an electronic device, comprising:
obtaining a first streaming motion of a user and a plurality of nodes of the first streaming motion according to images of the user, wherein each of the nodes of the first streaming motion comprises a plurality of coordinates, and each of the nodes of the first streaming motion belongs to a part of body;
providing a second streaming motion of a virtual coach and a plurality of nodes of the second streaming motion, wherein each of the nodes of the second streaming motion comprises a plurality of coordinates, and each of the nodes of the second streaming motion belongs to one of the parts of body;
calculating a plurality of relation values between the coordinates of the nodes of the first streaming motion and the coordinates of the nodes of the second streaming motion according to a streaming node comparison algorithm;
obtaining a plurality of weights via a weighting vector according to the parts of body, an exercise type preset by the user and a plurality of time information of the images;
generating a comparison result according to a result of the weights respectively multiplying the relation values; and
mapping the comparison result to a similarity value.

9. The motion comparison method as claimed in claim 8, wherein a number of the nodes of the user is 15, a number of the nodes of the virtual coach is 15.

10. The motion comparison method as claimed in claim 8, wherein the weights are real numbers, and values of the weights are greater than or equal to 0.1 and are smaller than or equal to 2.

11. The motion comparison method as claimed in claim 9, wherein the step of generating the comparison result comprises:
generating the comparison result according to the equation (1),
$${\sum }_{n ∈ Node}^{15} {W}_{mtn} \cdot {H}_{n} ( U , V ) \qquad ( 1 )$$
wherein, U is a vector comprising the coordinates of the nodes of the user, V is a vector comprising the coordinates of the nodes of the virtual coach, Wₘₜₙ is the weight corresponding to an n-th part of body in the parts of body, an m-th exercise type in the exercise types and a t-th second in the time information, Hₙ( ) is a function corresponding to the streaming node comparison algorithm and is used to calculate the relation value corresponding to the n-th part of body, in and n are positive integers, t is a real number, and Node is a set formed by the parts of body.

12. The motion comparison method as claimed in claim 8, wherein the streaming node comparison algorithm is a dynamic time warping algorithm, a Euclidean distance algorithm or a coefficient of correlation algorithm.

13. The motion comparison method as claimed in claim 8, wherein the step of mapping the comparison result to the similarity value comprises:
generate a plurality of second comparison results; and
obtaining a minimum comparison result and a maximum comparison result from the second comparison results, and mapping the comparison result to the similarity value in a similarity range according to the minimum comparison result and the maximum comparison result.

14. The motion comparison method as claimed in claim 13, wherein the similarity range is 0 to 100.
